(19) United States
(12) Patent Application Publication
(10) Pub. No.: US 2026/0231855 A1
(43) Pub. Date: Aug. 13, 2026

(54) BOOM SPREADER WITH SECTIONAL CONTROL

(71) Applicant: Salford Group Inc., Salford (CA)

(72) Inventors: Geof J. GRAY, Burford (CA); John Mark AVERINK, Norwich (CA); Ravikesh Ashok KHADTARE, Guelph (CA); Adam Peter LEHMAN, Kenilworth (CA); David G. WEBSTER, Okotoks (CA); Gavin HELD, Janesville, MN (US); Peter STOECKLI, Putnam (CA)

(21) Appl. No.: 19/471,084

(22) PCT Filed: Apr. 2, 2024
(86) PCT No.: PCT/CA2024/050419

§ 371 Date: Sep. 30, 2025

Related U.S. Application Data
(60) Provisional application No. 63/494,223, filed on Apr. 4, 2023.

(51) Int. Cl. A01C 15/12; A01C 15/04; A01C 15/18; A01C 19/02

(52) U.S. Cl. CPC A01C 15/122; A01C 15/04; A01C 15/18; A01C 19/02

(57) ABSTRACT

A boom spreader comprises side-by-side endless belts driven by drive shafts where the drive shafts each have a drive roller and a smooth non-drive roller mounted thereon. The smooth non-drive roller allows for variances in speed between the side-by-side endless belts by simple slippage or by providing a bearing or bushing between the smooth non-drive roller and the drive shaft. Thus, one of the endless belts can be driven more quickly or slowly or even stopped without unduly affecting drive control over the other endless belts.

### CROSS-REFERENCE TO RELATED APPLICATIONS

This application claims the benefit of U.S. provisional patent application 63/494,223 filed Apr. 4, 2023, the entire contents of which is herein incorporated by reference.

### FIELD

This application relates to agriculture, in particular to an apparatus for applying solid agricultural product to a field.

### BACKGROUND

An air boom spreader comprises a hopper for containing a particulate material (e.g., fertilizer, seed or other agricultural product), one or more transversely-extending booms comprising a plurality of outlets to distribute the particulate material in a field, a metering device for conveying the particulate material from the hopper toward the one or more booms and an air system comprising a blower and air lines that receive the particulate material from the metering device and The metering device may comprise one or more endless belts (also called chains) to deliver the particulate material from the metering device to each of the plurality of outlets of the one or more booms.

To help independently control the amount of particulate material that is delivered to each outlet, the metering system may comprise a plurality of independently controllable side-by-side endless belts. However, because the side-by-side endless belts are often transversely closely spaced-apart, it is often impossible to place drive motors between the belts. Other arrangements of drive motors need to be employed, resulting in increased complexity of the drive system. Some examples of such complex arrangements are described in WO 2019/157094, U.S. Pat. Nos. 10,207,873, 10,046,917 and the like.

There remains a need for a simpler drive system for independently controlling a plurality of side-by-side endless belts in a boom spreader for particulate material.

### SUMMARY

A boom spreader for spreading particulate material in a field comprises: a hopper for containing the particulate material; booms comprising a first boom and a second boom, the first boom and second boom transversely extendible in opposite transverse directions non-parallel to a direction of travel along a longitudinal axis of the spreader and non-perpendicular to the field, the booms comprising a plurality of outlets in particulate material communication with the hopper to distribute the particulate material in the field; and, a metering device for conveying the particulate material from the hopper to the booms, the metering device dividing the particulate material into portions for delivery to the plurality of outlets, the metering device comprising a plurality of endless belts that receive the particulate material from the hopper and convey the particulate material longitudinally from the hopper toward the booms, the plurality of endless belts comprising: a first set of side-by-side endless belts and a second set of side-by-side endless belts whereby the endless belts of the first and second sets are substantially parallel to and coplanar with each other, and each of the endless belts is independently drivable; a first set of drive shafts and a second set of drive shafts, each drive shaft having a drive roller mounted thereon for driving one of the endless belts of the respective first and second sets of endless belts, each drive shaft also having a smooth non-drive roller mounted thereon which is in contact with one of the endless belts not being driven by the drive shaft on which the smooth non-drive roller is mounted; and, a first set of drive motors and a second set of drive motors, each drive motor operatively connected to one of the drive shafts of respective first and second sets of drive shafts, wherein the drive shafts of the first set of drive shafts are longitudinally spaced-apart along the endless belts of the first set of endless belts and the drive motors of the first set of drive motors are connected to the drive shafts of the first set of drive shafts on a same side of the first set of endless belts remote from the second set of endless belts, and wherein the drive shafts of the second set of drive shafts are longitudinally spaced-apart along the endless belts of the second set of endless belts and the drive motors of the second set of drive motors are connected to the drive shafts of the second set of drive shafts on a same side of the second set of endless belts remote from the first set of endless belts.

The metering device comprises endless belts, drive shafts for driving the endless belts and drive motors for driving the drive shafts. Each of the drive shafts comprises a drive roller, which interacts with one of the endless belts to drive the endless belt, and a smooth non-drive roller which is in contact with another of the endless belts but does not drive the other of the endless belts. The drive roller may be, for example, a sprocket that engages apertures in the endless belt or any other suitable drive roller.

In some embodiments, at least one of the smooth non-drive rollers is a fixedly mounted smooth roller. The endless belt in contact with the fixedly mounted smooth roller slips on the fixedly mounted smooth roller when the endless belt in contact with fixedly mounted smooth roller is being driven at a different speed than a speed at which the fixedly mounted smooth roller is being driven. In some embodiments, at least one of the smooth non-drive rollers is a smooth roller rotatably mounted on one of the drive shafts. Here, the endless belt in contact with the rotatably mounted smooth roller causes the rotatably mounted smooth roller to rotate at a different speed than a speed of the drive shaft on which the smooth roller is rotatably mounted. One or more of the smooth non-drive rollers may be a fixedly mounted smooth roller while one or more of the smooth non-drive rollers may be a rotatably mounted smooth roller. To be rotatably mounted, the smooth roller may be mounted on a bearing or bushing on the drive shaft on which the smooth roller is mounted.

Because the smooth non-drive rollers permit an endless belt to be driven by a different drive shaft than the drive shaft in which the smooth roller is mounted without interfering with the operation of the different drive shaft, side-by-side endless belts can be independently controlled by different drive shafts that are longitudinally spaced apart and that are driven by their own drive motors, the drive motors being mounted on the same side of the set of endless belts as the drive motors in the same set, the drive motors also being longitudinally spaced apart. In such a configuration, the drive system is simplified without the need for complicated gearing or motor configurations. Thus, the use of one or more smooth non-drive rollers on the same drive shaft as a drive roller permits independent control of multiple endless belts while permitting standard drive motor configuration on the same side of a set of endless belts thereby permitting the side-by-side endless belts to be transversely very close to each other.

In some embodiments, the endless belts of the first set of endless belts loop around one of the drive shafts of the first set of drive shafts. In some embodiment, the endless belts have upper and lower belt segments and the drive shaft around which the endless belts of the first set of endless belts of the first set of endless belts are looped is between the upper and lower belt segments of the endless belts of the first set of endless belts. Further, at least one other of the drive shafts of the first set of drive shafts can be situated underneath and in contact with the lower belt segments of the first set of endless belts. Likewise, in some embodiments, the endless belts of the second set of endless belts loop around one of the drive shafts of the second set of drive shafts. Further, the endless belts of the second set of endless belts have upper and lower belt segments and the drive shaft around which the endless belts of the second set of endless belts are looped is between the upper and lower belt segments of the endless belts of the second set of endless belts. Furthermore, at least one other of the drive shafts of the second set of drive shafts can be situated underneath and in contact with the lower belt segments of the second set of endless belts.

Each set of side-by-side endless belts may comprise two, three, four or more endless belts and corresponding drive shafts and drive motors. In some embodiments, the first set of side-by-side endless belts comprises two endless belts, the second set of side-by-side endless belts comprises two endless belts, the first set of drive shafts comprises two drive shafts, the second set of drive shafts comprises two drive shafts, the first set of drive motors comprises two drive motors, the second set of drive motors comprises two drive motors, and each drive shaft has one drive roller and one non-drive roller mounted thereon.

The boom spreader may further comprise an air system configured to deliver the particulate material from the metering device to each of the plurality of outlets of the booms. The air system may comprise a plurality of air lines and a blower configured to transport the particulate material from the metering device to the plurality of outlets. The particulate material may be any suitable solid material, for example a fertilizer, seed, another solid agricultural product, lime or any combination thereof. The hopper may comprise multiple compartments containing different particulate material.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a top view of an air boom spreader.

FIG. 2 depicts a top view of a rear of the air boom spreader of FIG. 1.

FIG. 3 depicts a bottom perspective view of a rear portion of side-by-side endless belts of the air boom spreader of FIG. 1.

FIG. 4 depicts a perspective view of an arrangement of drive motors, drive shafts and various rollers that operate the endless belts in FIG. 3.

FIG. 5 depicts a top view of the endless belts in FIG. 3.

FIG. 6 depicts a left side view of the endless belts in FIG. 3.

FIG. 7 depicts a right side view of the endless belts in FIG. 3.

FIG. 8A depicts a perspective view of one of the drive shafts shown in FIG. 4.

FIG. 8B depicts a left side view of the drive shaft of FIG. 8A.

FIG. 8C depicts a right side view of the drive shaft of FIG. 8A.

### DETAILED DESCRIPTION

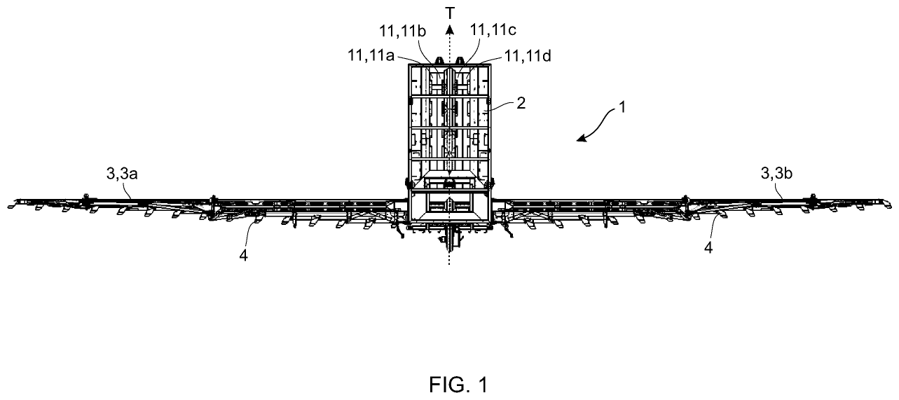

FIG. 1 depicts an air boom spreader 1 for spreading particulate material (e.g., lime, a fertilizer, seed and/or other solid agricultural product) in a field or other location. The spreader 1 may be a self-driven vehicle or a vehicle towed behind a primer mover (e.g., a tractor or the like). The spreader 1 comprises a hopper 2 for containing the particulate material and a pair of transversely extendible booms 3 situated at a rear of the spreader 1, including a first boom 3a and a second boom 3b. The booms 3 can be extended in opposite transverse directions non-parallel to a direction of travel T along a longitudinal axis of the spreader 1 and non-perpendicular to the field. The booms 3 comprise a plurality of outlets 4 (only two labeled) through which the particulate material is spread on to the field. The booms 3 can be folded inward toward the hopper 2 and/or upward to reduce the spreader's transverse profile for driving on roadways between fields.

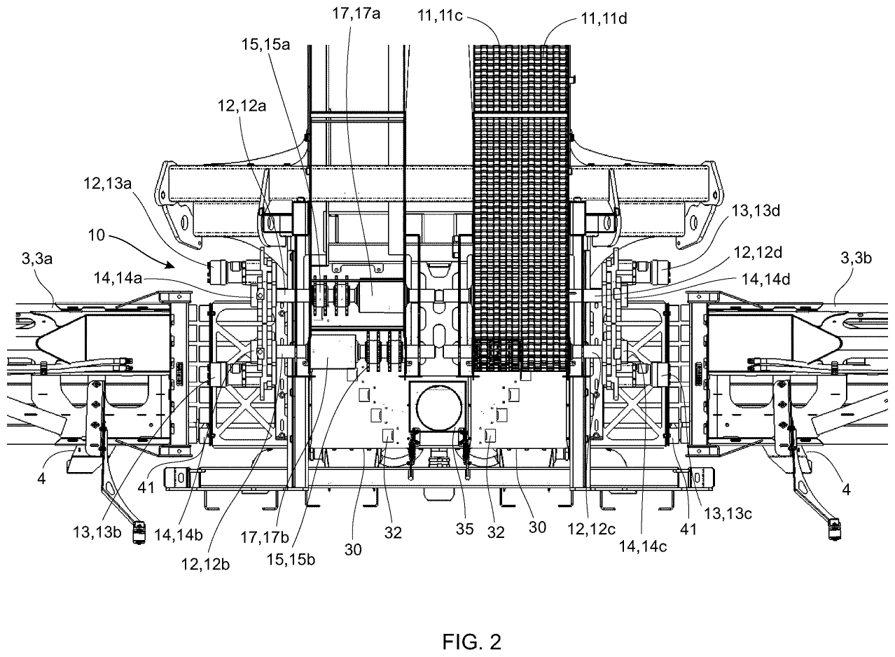

FIG. 2 provides a magnified view of the rear end of the spreader 1 with the hopper removed for clarity. The spreader 1 comprises a metering device 10, which comprises two sets of endless belts 11, a first set comprising a pair of side-by-side endless belts 11a, 11b (see FIG. 1) and a second set comprising a pair of side-by-side endless belts 11c, 11d. The belts of the first set of endless belts 11a, 11b are omitted from FIG. 2 to illustrate structures below top portions of the belts. The metering device 10 also comprises gate boxes 30 having respective inlet apertures 32 (only one labeled for each gate box) that allow particulate material falling off the endless belts 11 to enter individual gates in the gate boxes 30. The individual gates are each in particulate material communication with respective air lines 41 (only one labeled for each gate box), which, under operation of a blower 35, deliver the particulate material to the outlets 3 for spreading on the field. Air lines from the blower 35 to the air lines 41 are not shown for clarity. Details of the operation of a boom spreader are generally known, for example as disclosed in WO 2018/170594 published Sep. 27, 2018, the entire contents of which is herein incorporated by reference.

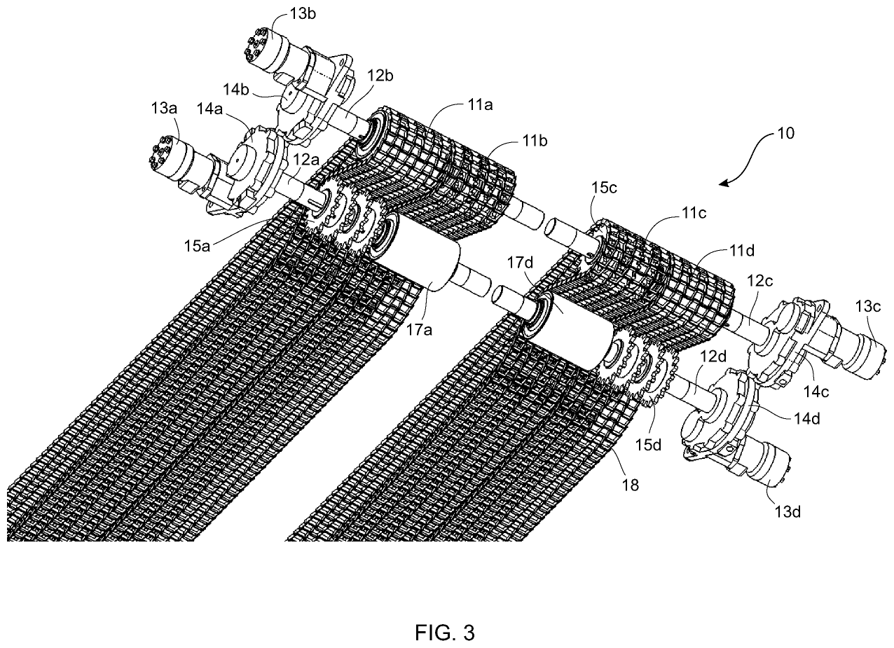

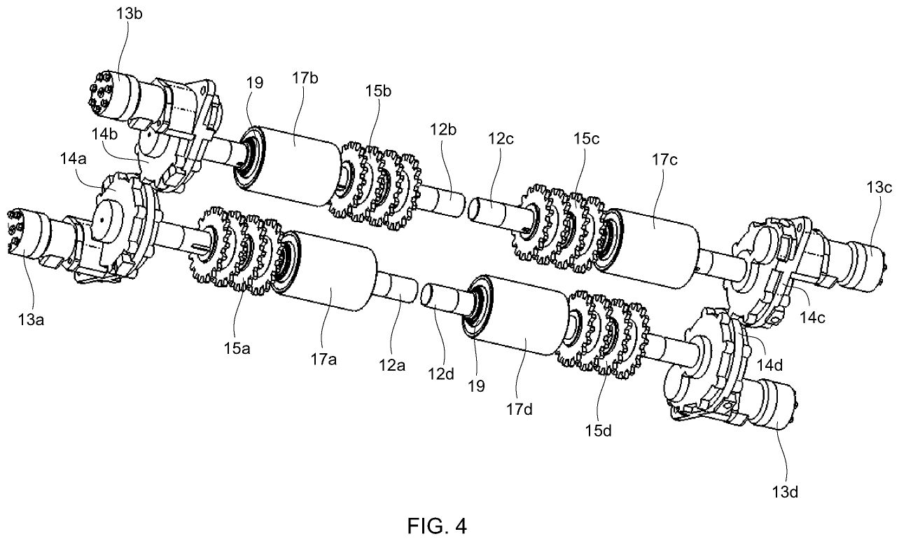

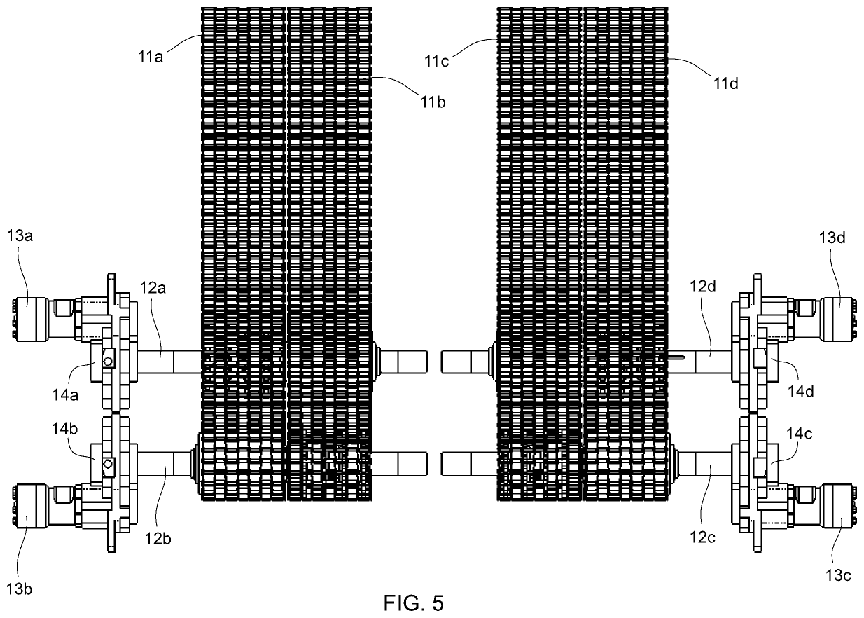

With further reference to FIG. 3 to FIG. 7, the metering device 10 further comprises drive shafts 12 with drive rollers 15 mounted thereon, where drive shaft 12a with drive roller 15a drives endless belt 11a, drive shaft 12b with drive roller 15b drives endless belt 11b, drive shaft 12c with drive roller 15c drives endless belt 11c, and drive shaft 12d with drive roller 15d drives endless belt 11d. The drive shafts 12 are operatively connected to dedicated drive motors 13 through motor mounts 14, where drive motor 13a mounted on motor mount 14a drives drive shaft 12a, drive motor 13b mounted on motor mount 14b drives drive shaft 12b, drive motor 13c mounted on motor mount 14c drives drive shaft 12c, and drive motor 13d mounted on motor mount 14d drives drive shaft 12d. The drive rollers 15 each comprise at least one sprocket, for example four sprockets as shown in FIG. 3, teeth of which engage rows of apertures 18 (only one labeled) in the endless belts 11 to drive the endless belts 11. The drive shafts 12 have mounted thereon smooth non-drive rollers 17 that are transversely separated from the respective drive rollers 15 on the respective drive shafts 12. Thus, the drive shaft 12a has smooth non-drive roller 17a mounted thereon, the drive shaft 12b has smooth non-drive roller 17b mounted thereon, the drive shaft 12c has smooth non-drive roller 17c mounted thereon, and the drive shaft 12d has smooth non-drive roller 17d mounted thereon. The endless belts 11a and 11b of the first set of endless belts are side-by-side and very closely spaced, that is the endless belts 11a and 11b are parallel to and coplanar with each other. As such, there is no space between the endless belts 11a and 11b to situate a drive motor. Likewise, the endless belts 11c and 11d of the second set of endless belts are side-by-side and very closely spaced, that is the endless belts 11c and 11d are parallel to and coplanar with each other. As such, there is no space between the endless belts 11c and 11d to situate a drive motor. Further, the first set of endless belts 11a and 11b and the second set of endless belts 11c and 11d are also side-by-side, the two sets being parallel to and coplanar with each other having insufficient space between the two sets to situate drive motors.

The standard and simplest way to configure the drive motor 13 and the drive shaft 12 for each endless belt 11 is to mount the drive motor 13 at an end of the drive shaft 12 and fixedly mount the drive roller 15 on the drive shaft 12 so that the drive roller 15 engages the endless belt 11 to drive the endless belt 11. Because it is impossible to situate a drive motor between any of the belts, the drive motors must be situated at the outsides of the sets of belts, or above or below the sets of belts. To utilize the standard configuration without interfering with individual control over every endless belt 11 and without utilizing complicated gearing and motor mounts, the drive shafts 12 for each set of endless belts 11 are long enough to pass transversely across an entire width of a set of endless belts 11, and the drive shafts 12 are longitudinally spaced-apart along the endless belts 11 of the set. Further, the smooth non-drive roller 17 on a particular drive shaft 12 is situated on the particular drive shaft 12 to engage an endless belt other than the endless belt that is being driven by the particular drive shaft 12. Thus, the smooth non-drive roller 17a on the drive shaft 12a is situated to engage the endless belt 11b, the smooth non-drive roller 17b on the drive shaft 12b is situated to engage the endless belt 11a, the smooth non-drive roller 17c on the drive shaft 12c is situated to engage the endless belt 11d, and the smooth non-drive roller 17d on the drive shaft 12d is situated to engage the endless belt 11c. The drive motors 13 are mounted through the motor mounts 14 at outside ends of the drive shafts 12 in the standard configuration, the drive motors 13 for each set of endless belts 11 being longitudinally spaced apart from each other along the endless belts 11 of the set. The drive motors 13a and 13b of the first set of endless belts 11a and 11b, respectively, are situated transversely opposite from the drive motors 13c and 13d of the second set of endless belts 11c and 11d, respectively, the drive motors 13a, 13b and 13c, 13d being situated at the outsides of respective sets of endless belts 11a, 11b and 11c, 11d.

If there are more than two endless belts in a set of endless belts, the drive shafts for that set can be lengthened and more smooth non-drive rollers added to each drive shaft to accommodate the extra belts. Furthermore, if desired, all the drive motors can be mounted on the same side of the metering device longitudinally spaced apart along the endless belts by using drive shafts of sufficient length to transversely span all the endless belts and mounting enough smooth non-drive rollers on each drive shaft to engage all the endless belts.

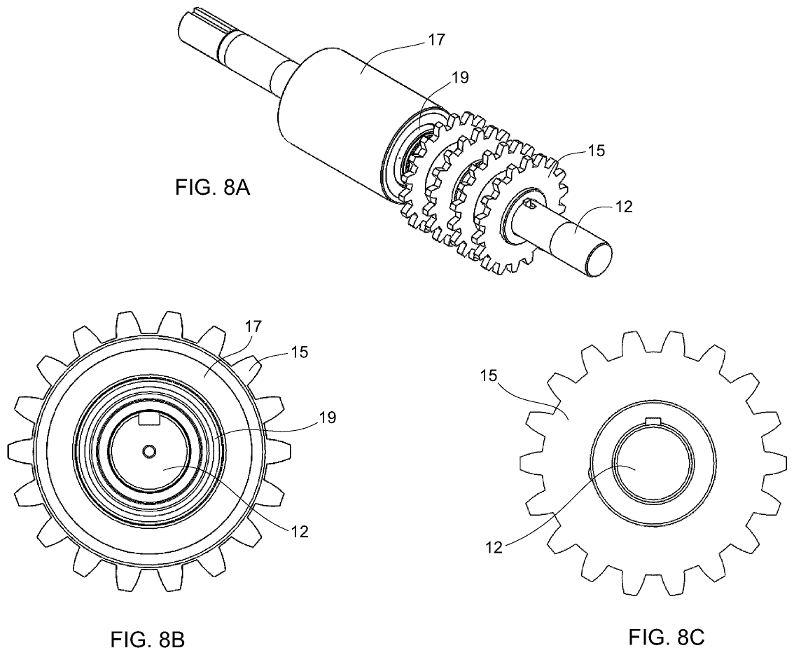

The smooth non-drive rollers 17 engage endless belts 11 that are not driven by the same drive shafts 12 on which the smooth non-drive rollers 17 are mounted. As seen in FIG. 8A to FIG. 8C, the smooth non-drive rollers 17 are rotatably mounted on the drive shafts 12 through bearings 19. The bearings 19 are rotatably mounted on the drive shafts 12 so that rotation of the drive shafts 12 will not cause the smooth non-drive rollers 17 to rotate, while rotation of the smooth non-drive rollers 17 caused by translational movement of the endless belts 11 with which the smooth non-drive rollers 17 are engaged will cause the bearings 19 to rotate on the drive shafts 12 without imparting any rotational motion to the drive shafts 12. Thus, the speed of the endless belts 11 can be independently controlled to provide sectional control over the delivery of the particulate material to the booms 3 and to the outlets 4 of the booms 3. If the bearings 19 are not used and the smooth non-drive rollers 17 are fixedly mounted on the drive shafts 12, slippage between the smooth non-drive rollers 17 and the endless belts 11 prevents rotational movement of the smooth non-drive rollers 17 from affecting drive control of the endless belts 11 to which the non-drive rollers 17 are engaged. The slippage also prevents the translational movement of the endless belts 11 engaged with the smooth non-drive rollers 17 from affecting drive control of the endless belts 11 which are driven by the drive shafts 12 on which the non-drive rollers 17 are mounted.

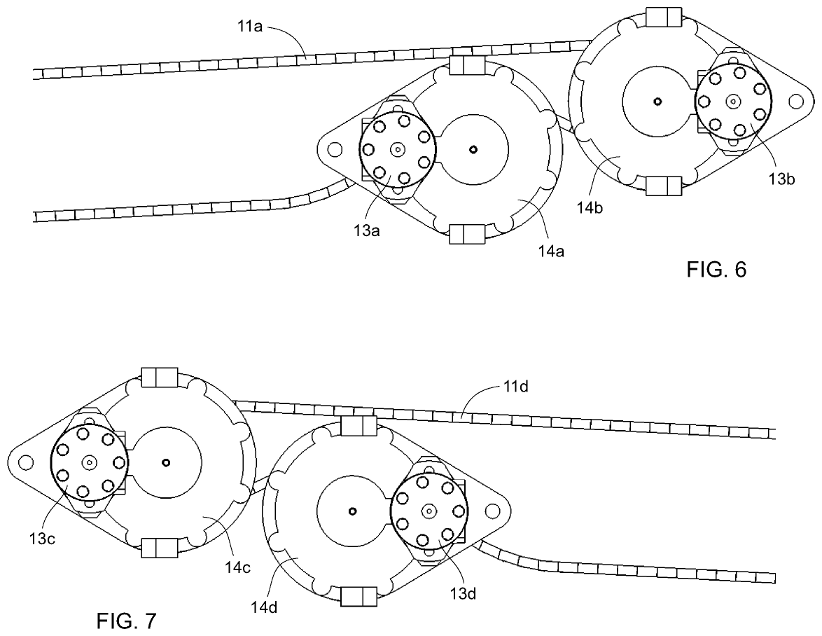

The shaft and roller arrangement also facilitates tensioning of the endless belts 11. As shown in FIG. 3, FIG. 6 and FIG. 7, the endless belts 11 can be looped around rearmost drive shafts 12b and 12c and lower belt segments of the endless belts 11 passed over top of more forward drive shafts 12a and 12d so that the rearmost drive shafts 12b and 12c are between upper and lower belt segments of the endless belts 11 while the more forward drive shafts 12a and 12d are underneath and in contact with the lower belt segments of the first set of endless belts 11. Setting the height of the more forward drive shafts 12a and 12d in relation to the rearmost drive shafts 12b and 12c sets the tension on the endless belts 11. Without the presence of the smooth non-drive rollers 17 on the drive shafts 12, such tension would not be possible, or would at least be more difficult to attain, in the context of the side-by-side endless belts 11.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A boom spreader for spreading particulate material in a field, the spreader comprising:
a hopper for containing the particulate material;
booms comprising a first boom and a second boom, the first boom and second boom transversely extendible in opposite transverse directions non-parallel to a direction of travel along a longitudinal axis of the spreader and non-perpendicular to the field, the booms comprising a plurality of outlets in particulate material communication with the hopper to distribute the particulate material in the field; and,
a metering device for conveying the particulate material from the hopper to the booms, the metering device dividing the particulate material into portions for delivery to the plurality of outlets, the metering device comprising a plurality of endless belts that receive the particulate material from the hopper and convey the particulate material longitudinally from the hopper toward the booms, the plurality of endless belts comprising:
a first set of side-by-side endless belts and a second set of side-by-side endless belts whereby the endless belts of the first and second sets are substantially parallel to and coplanar with each other, and each of the endless belts is independently drivable;
a first set of drive shafts and a second set of drive shafts, each drive shaft having a drive roller mounted thereon for driving one of the endless belts of the respective first and second sets of endless belts, each drive shaft also having a smooth non-drive roller mounted thereon which is in contact with one of the endless belts not being driven by the drive shaft on which the smooth non-drive roller is mounted; and,
a first set of drive motors and a second set of drive motors, each drive motor operatively connected to one of the drive shafts of respective first and second sets of drive shafts,
wherein the drive shafts of the first set of drive shafts are longitudinally spaced-apart along the endless belts of the first set of endless belts and the drive motors of the first set of drive motors are connected to the drive shafts of the first set of drive shafts on a same side of the first set of endless belts remote from the second set of endless belts,
and wherein the drive shafts of the second set of drive shafts are longitudinally spaced-apart along the endless belts of the second set of endless belts and the drive motors of the second set of drive motors are connected to the drive shafts of the second set of drive shafts on a same side of the second set of endless belts remote from the first set of endless belts.

2. The boom spreader of claim 1, wherein the endless belts of the first set of endless belts loop around one of the drive shafts of the first set of drive shafts.

3. The boom spreader of claim 2, wherein the endless belts have upper and lower belt segments, the drive shaft around which the endless belts of the first set of endless belts looped is between the upper and lower belt segments of the endless belts of the first set of endless belts, and at least one other of the drive shafts of the first set of drive shafts is situated underneath and in contact with the lower belt segments of the first set of endless belts.

4. The boom spreader of claim 1, wherein: the endless belts of the second set of endless belts loop around one of the drive shafts of the second set of drive shafts; the endless belts have upper and lower belt segments; and, the drive shaft around which the endless belts of the second set of endless belts are looped is between the upper and lower belt segments of the endless belts of the second set of endless belts, and at least one other of the drive shafts of the second set of drive shafts is situated underneath and in contact with the lower belt segments of the second set of endless belts.

5. The boom spreader of claim 1, wherein the first set of side-by-side endless belts comprises two endless belts, the second set of side-by-side endless belts comprises two endless belts, the first set of drive shafts comprises two drive shafts, the second set of drive shafts comprises two drive shafts, the first set of drive motors comprises two drive motors, the second set of drive motors comprises two drive motors, and each drive shaft has one drive roller and one non-drive roller mounted thereon.

6. The boom spreader of claim 1, wherein at least one of the smooth non-drive rollers is a fixedly mounted smooth roller whereby the endless belt in contact with the fixedly mounted smooth roller slips on the fixedly mounted smooth roller when the endless belt in contact with fixedly mounted smooth roller is being driven at a different speed than a speed at which the fixedly mounted smooth roller is being driven.

7. The boom spreader of claim 1, wherein at least one of the smooth non-drive rollers is a smooth roller rotatably mounted on one of the drive shafts whereby the endless belt in contact with the rotatably mounted smooth roller causes the rotatably mounted smooth roller to rotate at a different speed than a speed of the drive shaft on which the smooth roller is rotatably mounted.

8. The boom spreader of claim 7, wherein the smooth roller is mounted on a bearing or bushing on the drive shaft on which the smooth roller is mounted.

9. The boom spreader of claim 1 further comprising an air system configured to deliver the particulate material from the metering device to each of the plurality of outlets of the booms.

10. The spreader of claim 9, wherein the air system comprises a plurality of air lines and a blower configured to transport the particulate material from the metering device to the plurality of outlets.

11. The spreader of 1, wherein the particulate material comprises a fertilizer.
